(19) United States
(12) Patent Application Publication
(10) Pub. No.: US 2014/0180878 A1
(43) Pub. Date: Jun. 26, 2014

(54) ELECTRONIC SHOPPING SYSTEM AND METHOD

(71) Applicant: HON HAI PRECISION INDUSTRY CO., LTD., New Taipei (TW)

(72) Inventor: CHENG-TA HSU, New Taipei (TW)

(73) Assignee: HON HAI PRECISION INDUSTRY CO., LTD., New Taipei (TW)

(21) Appl. No.: 13/873,134

(22) Filed: Apr. 29, 2013

(30) Foreign Application Priority Data
Dec. 25, 2012 (TW) 101149681

(51) Int. Cl. G06Q 30/06

(52) U.S. Cl. CPC G06Q 30/0639
USPC 705/26.81

(57) ABSTRACT

A cloud server receives an order and position information from a mobile device. The cloud server then determines which store have the product in the order, determines the store nearest the mobile device according to stored position information of stores and the received position information when two or more stores have the product. The cloud sever then transmits the order to a terminal of the nearest store, receives order information from the terminal, and transmits the order information and the position information of the nearest store to the mobile device. A related electronic shopping method and storage medium are also disclosed.

### BACKGROUND

1. Technical Field

The present disclosure relates to cloud computing technology, and particularly to an electronic shopping system and a method for shopping via a cloud server.

2. Description of Related Art

It is desirable for people to buy needed products in less time. However, when people are in an unfamiliar place, they may spend a lot of time to trying to find the right place to find the needed products. Therefore, there is room for improvement in the art.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a cloud server, in accordance with an exemplary embodiment.

FIG. 2 is a block diagram of function modules of an electronic shopping system, in accordance with an exemplary embodiment.

FIG. 3 is a flowchart of an electronic shopping method, in accordance with an exemplary embodiment.

### DETAILED DESCRIPTION

Embodiments of the present disclosure will now be described in detail, with reference to the accompanying drawings.

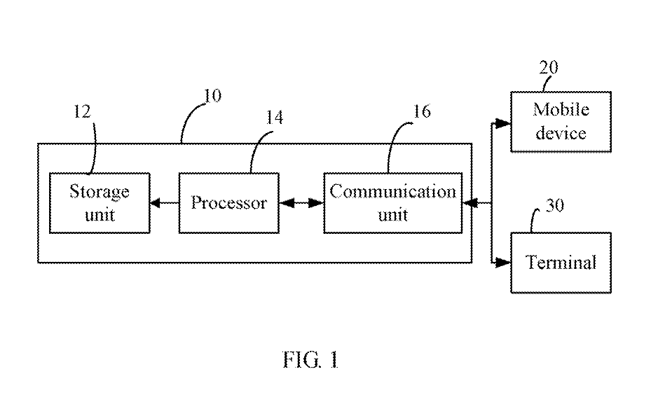

FIG. 1 shows an embodiment of a cloud server 10. The cloud server 10 communicates with a number of mobile devices 20 and terminals 30 of a number of stores.

The cloud server 10 sets passwords and names for enabling the mobile devices 20 and the terminals 30 to access the cloud server 10.

The cloud server 10 includes a storage unit 12, a processor 14, and a communication module 16. The communication module 16 communicates among the cloud server 10, the mobile devices 20, and the terminals 30. The storage unit 12 stores product information of each store, such as, product barcodes, and product prices, for example. The product barcodes can be two-dimensional barcodes or three-dimensional barcodes. The storage unit 12 further stores position information of each store. When the terminals 30 can access the cloud server 10, the terminals 30 can upload product information of the store to the cloud server 10. The storage unit 12 further stores an electronic shopping system 100 executable by the processor 14.

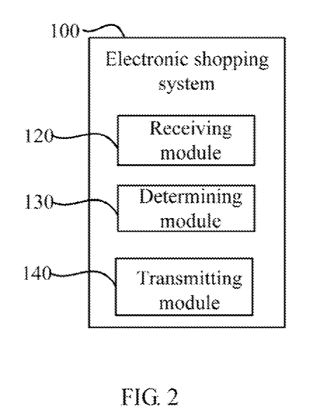

FIG. 2 shows block diagrams of function modules of the electronic shopping system 100 in accordance with an exemplary embodiment. The electronic shopping system 100 includes a receiving module 120, a determining module 130, and a transmitting module 140.

The receiving module 120 receives an order and position information from each mobile device 20. The order includes one or more product barcodes, order quantity of each product, and shipping methods. The shipping methods include picking up by customers and delivering.

The determining module 130 determines which store have the products in the order according to the product information stored in the storage unit 12 and the product barcodes in the order. When two or more stores have the products in the order, the determining module 130 determines the store nearest the mobile device 20 according to the position information received from the mobile device 20 and the position information stored in the storage unit 12.

The transmitting module 140 transmits the order to the terminal 30 of the store nearest the mobile device 20 (hereinafter, nearest terminal 30), receives order information from the nearest terminal 30, and transmits the order information and the position information of the nearest store to the mobile device 20. The order information includes amount payable, payment options, shipping methods, and shipping time. When the mobile device 20 receives the order information, the owner of the mobile device 20 pays the ordered products. When the nearest terminal 30 receives a payment notice, the nearest store may deliver the ordered products to the owner of the mobile device 20.

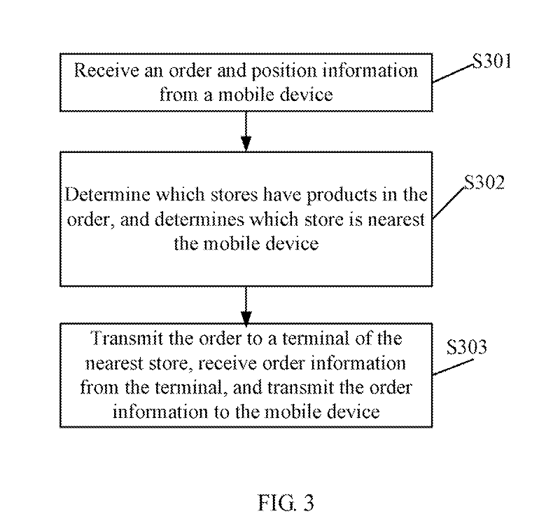

FIG. 3 is a flowchart of an electronic shopping method, in accordance with an exemplary embodiment.

In step S301, the receiving module 120 receives an order and position information from one mobile device 20.

In step S302, the determining module 130 determines which store have the products in the order according to the product information stored in the storage unit 12 and the product barcodes in the order, and when two or more stores have the products in the order, the determining module 130 determines the store nearest the mobile device 20 according to the position information received from the mobile device 20 and the position information stored in the storage unit 12.

In step S303, the transmitting module 140 transmits the order to the nearest terminal 30, receives a order information from the nearest terminal 30, and transmits the order information and the position information of the nearest store to the mobile device 20.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A cloud server communicating with a mobile device and terminals of stores, comprising:
a storage unit storing product information and position information of each store, the product information comprising product barcodes of products of each store;
at least one processor; and
an electronic shopping system stored in the storage unit and being executable by the at least one processor, the electronic shopping system comprising:
a receiving module to receive an order and position information from the mobile device, the order comprising at least one product barcode;
a determining module to determine which store have the at least one product in the order according to the stored product information and the at least one product barcode in the order, and when two or more stores have the at least one product, the determining module being further to determine the store nearest the mobile device according to the stored position information and the received position information; and
a transmitting module to transmit the received order to the terminal of the store nearest the mobile device, receive order information from the terminal of the store nearest the mobile device, and transmit the order information and the position information of the store nearest the mobile device to the mobile device.

2. The cloud server as described in claim 1, wherein each of the product barcode is a two-dimensional or three-dimensional barcode.

3. An electronic shopping method to be executed by a processor of a cloud server, the cloud server communicating with a mobile device and terminals of stores, the cloud server storing product information and position information of each store, the product information comprising product barcodes of products of each store, the electronic shopping method comprising:
receiving an order and position information from the mobile device, the order comprising at least one product barcode;
determining which store have the at least one product in the order according to the stored product information and the at least one product barcode in the order;
determining the store nearest the mobile device according to the stored position information and the received position information when two or more stores have the at least one product; and
transmitting the received order to the terminal of the store nearest the mobile device, receiving order information from the terminal of the store nearest the mobile device, and transmitting the order information and the position information of the store nearest the mobile device to the mobile device.

4. A storage medium storing a plurality of modules, the plurality of modules comprising instructions executable by a processor of a cloud server to perform an electronic shopping method, the cloud server communicating with a mobile device and terminals of stores, the cloud server storing product information and position information of each store, the product information comprising product barcodes of products of each store, the method comprising:
receiving an order and position information from the mobile device, the order comprising at least one product barcode;
determining which store have the at least one product in the order according to the stored product information and the at least one product barcode in the order;
determining the store nearest the mobile device according to the stored position information and the received position information when two or more stores have the at least one product; and
transmitting the received order to the terminal of the store nearest the mobile device, receiving order information from the terminal of the store nearest the mobile device, and transmitting the order information and the position information of the store nearest the mobile device to the mobile device.
